(19) United States
(12) Patent Application Publication
(10) Pub. No.: US 2020/0154654 A1
(43) Pub. Date: May 21, 2020

(54) METHOD AND SYSTEM FOR IRRIGATION

(71) Applicant: N-Drip Ltd., Bnei Atarot (IL)

(72) Inventors: Uri SHANI, Tel-Aviv (IL); Xiaohong XIA, Mevaseret Zion (IL); Asher VITNER, Jerusalem (IL); Boaz ROZENGARTEN, Jerusalem (IL); Sharon DABACH, Tel-Aviv (IL); Zvi MILLER, Kiryat-Tivon (IL)

(73) Assignee: N-Drip Ltd., Bnei Atarot (IL)

(21) Appl. No.: 16/774,055

(22) Filed: Jan. 28, 2020

Related U.S. Application Data
(62) Division of application No. 15/770,761, filed on Apr. 25, 2018.
(60) Provisional application No. 62/332,017, filed on May 5, 2016.

(51) Int. Cl. A01G 25/02

(52) U.S. Cl. CPC A01G 25/02; A01G 25/023

(57) ABSTRACT

A method of irrigation is disclosed. The method comprises supplying water to an inclined irrigation pipe provided with a plurality of drippers. The water is supplied such that a pressure at a highest level of the inclined irrigation pipe is at most 90 cm H₂O.

### RELATED APPLICATIONS

This application is a division of U.S. patent application Ser. No. 15/770,761 filed on Apr. 25, 2018, which is a National Phase of PCT Patent Application No. PCT/IL2017/050494 having International Filing Date of May 4, 2017, which claims the benefit of priority under 35 USC § 119(e) of U.S. Provisional Patent Application No. 62/332,017 filed on May 5, 2016. The contents of the above applications are all incorporated by reference as if fully set forth herein in their entirety.

### FIELD AND BACKGROUND OF THE INVENTION

The present invention, in some embodiments thereof, relates to irrigation and, more particularly, but not exclusively, to method and system for irrigation at low water pressure.

Drip irrigation is a watering method that utilizes pressurized water sources and drips water along a distribution pipe in a controlled manner.

Drip irrigation systems are considered to be more efficient than surface irrigation systems that typically convey water to fields in open canals or low pressure pipelines. Surface irrigation systems require smaller investment and lower energy costs, and these systems typically employ high discharge at the inlet in order to irrigate efficiently and uniformly across a field so that water will reach the end of the field.

U.S. Pat. No. 7,048,010 discloses a distribution pipe made of thin-walled sleeve that is collapsible when empty and that includes holes in its walls Branch tubes equipped with low-pressure drip emitters are connected to the holes of the distribution pipe by connectors. The sleeve material is opaque and reflecting the solar radiation so that the growth of microorganisms and algae is suppressed, the pipe is not heated more than 35° C. above the ambient air temperature.

### SUMMARY OF THE INVENTION

According to some embodiments of the invention the present invention there is provided a method of irrigation. The method comprises supplying water to an inclined irrigation pipe provided with a plurality of drippers, wherein the supplying is such that a pressure at a highest level of the inclined irrigation pipe is at most 90 cm H₂O.

According to an aspect of some embodiments of the present invention there is provided a method of irrigation. The method comprises supplying water to an inclined irrigation pipe provided with a plurality of drippers, wherein the irrigation pipe is inclined at a varying slope and wherein the supplying is selected to provide a predetermined pressure at a highest level of the inclined irrigation pipe, the predetermined pressure and the varying slope being selected such that a discharge rate along a length of the inclined irrigation pipe varies by no more than 20%. In some embodiments of the invention the supplying is such that a pressure at a highest level of the inclined irrigation pipe is at most 90 cm H₂O.

According to an aspect of some embodiments of the present invention there is provided a method of deploying an irrigation pipe. The method comprises: operating a shoveling tool to form a varying slope in a soil; deploying, generally along the varying slope, an inclined irrigation pipe having a plurality of drippers; wherein a variation in the varying slope is selected such that when the irrigation pipe is fed with water at a predetermined pressure, a water discharge along a length of the inclined irrigation pipe varies by no more than 20%.

According to some embodiments of the invention the water pressure is from about 5 cm H₂O to about 90 cm H₂O at a highest level of the inclined irrigation pipe.

According to some embodiments of the invention the water is supplied by a water distribution conduit.

According to some embodiments of the invention at least one of the drippers is characterized by a pressure-discharge dependence which comprises a linear relation between a discharge rate at an outlet of the dripper and an inlet pressure at an inlet of the dripper.

According to some embodiments of the invention the linear relation is characterized by a coefficient of the inlet pressure which is from about 7 cubic centimeters per hour per cm H₂O to about 40 cubic centimeters per hour per cm H₂O. According to some embodiments of the invention the coefficient is from about 7 cubic centimeters per hour per cm H₂O to about 20 cubic centimeters per hour per cm H₂O. According to some embodiments of the invention the coefficient is from about 9 cubic centimeters per hour per cm H₂O to about 12 cubic centimeters per hour per cm H₂O.

According to some embodiments of the invention the linear relation is characterized by an offset parameter from about 0 to about 50 cubic centimeters per hour. According to some embodiments of the invention the offset parameter first coefficient is from about 10 cubic centimeters per hour to about 40 cubic centimeters per hour. According to some embodiments of the invention the offset parameter is from about 20 cubic centimeters per hour to about 30 cubic centimeters per hour.

According to some embodiments of the invention a number of drippers per meter length of the inclined irrigation pipe of from about 1 to about 5.

According to some embodiments of the invention for at least one pair of drippers in the pipe, a ratio between a value of the slope at a location of a first dripper of the pair and a value of the slope at a location of a second dripper of the pair, is equal or approximately equal to an nth power of a ratio between distances of a lowermost point of the pipe from the first and the second drippers of the pair, wherein the n is from about 1.5 to about 4.5.

According to an aspect of some embodiments of the present invention there is provided an irrigation system. The irrigation system comprises: an inclined irrigation pipe having a plurality of drippers configured to discharge water; a water supply system configured to deliver water to the inclined irrigation pipe at a highest level of the inclined irrigation pipe at a pressure of at most about 90 cm H₂O.

According to an aspect of some embodiments of the present invention there is provided an irrigation system. The system comprises: an inclined irrigation pipe having a plurality of drippers configured to discharge water; a water supply system configured to deliver water to the inclined irrigation pipe at a highest level of the inclined irrigation pipe; wherein the irrigation pipe is inclined at a varying slope selected such that a water pressure along a length of the inclined irrigation pipe varies by no more than about 20%.

According to some embodiments of the invention the irrigation system comprises a water distribution conduit.

According to some embodiments of the invention the water supply system comprises at least one of: a water reservoir, a water tank and a pump.

According to an aspect of some embodiments of the present invention there is provided a water irrigation dripper. The water irrigation dripper comprises: an external hollow element having at least one water inlet configured to intake water and at least one water outlet configured to discharge water from the dripper; and an internal element placed inside the external hollow element to form a water pathway in a space therebetween.

According to some embodiments of the invention a length of the water pathway is from about 0.5 cm to about 10 cm. According to some embodiments of the invention the length of the water pathway is from about 2 cm to about 5 cm.

According to some embodiments of the invention a diameter of the internal element is from about 0.25 mm to about 5 mm. According to some embodiments of the invention the diameter of the internal element is from about 0.75 mm to about 2.5 mm.

According to some embodiments of the invention a hydraulic diameter of the water pathway is from about 0.01 mm to about 5 mm. According to some embodiments of the invention a hydraulic diameter of the water pathway of from about 0.01 mm to about 1 mm.

According to some embodiments of the invention there is a plurality of water inlets at a density of from about 1 water inlet to about 10 water inlets per square centimeter. According to some embodiments of the invention the water pathway at least partially surrounds the internal element.

According to some embodiments of the invention the water inlet has a generally elliptic shape.

According to some embodiments of the invention the walls of the water inlet are generally perpendicular to an outer surface of the external hollow element.

According to some embodiments of the invention the water irrigation dripper comprises a water filter at one or more of the water inlets.

According to some embodiments of the invention the water irrigation dripper comprises at least one additional water inlet, oriented diagonally with respect to a normal to an outer surface of the external hollow element.

According to an aspect of some embodiments of the present invention there is provided an irrigation system. The irrigation system comprises a water supply source, and an irrigation pipe having a plurality of drippers configured to discharge water and being connected to the water supply source. Wherein at least one of the drippers is the dripper as delineated above and optionally and preferably as further exemplified below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an irrigation system;

FIG. 2 is a schematic illustration of a dripper;

FIGS. 3A and 3B are schematic illustrations of an irrigation system, according to some embodiments of the present invention;

FIG. 4 is a schematic illustration of an irrigation system having a varying slope, according to some embodiments of the present invention;

FIG. 5A is a cross-sectional illustration of the dripper in embodiments in which the assembled dripper has a plurality of holes;

FIG. 5B is a schematic illustration showing a perspective view of the assembled dripper in embodiments in which the assembled dripper has a plurality of holes;

FIG. 5C is schematic illustration showing an exploded view of an external hollow element (right side) and an internal element (left side), providing, when assembled together, a dripper according to some embodiments of the present invention;

FIG. 6 is a schematic illustration showing a perspective view of the dripper in embodiments in which the assembled dripper has an obstacle in its water pathway;

FIGS. 7A and 7B are schematic illustrations of a horizontal (FIG. 7A) and a vertical (FIG. 7B) orientations of the dripper in a water supply conduit according to some embodiments of the present invention;

FIGS. 8A and 8B are cross-sectional illustrations of a partial water pathway inside the dripper, according to some embodiments of the present invention;

FIGS. 9A-9L are schematic illustrations showing cross-sectional views of several assembled drippers, according to some embodiments of the present invention;

FIG. 10A is a schematic illustration showing a perspective view of the assembled dripper in embodiments in which the assembled dripper has an elliptically shaped and water inlet comprising a filter;

FIG. 10B is a schematic illustration showing a perspective view of the assembled dripper in embodiments in which the assembled dripper has an elliptically shaped water inlet;

FIGS. 10C and 10D are schematic illustrations showing a cross sectional view (FIG. 10C) and a perspective side view (FIG. 10D) of the assembled dripper in embodiments in which the assembled dripper has an elliptically shaped water inlet and an additional water inlet oriented diagonally with respect to a normal to an outer surface of an external hollow element;

FIGS. 10E and 10F are schematic illustrations showing a perspective view (FIG. 10E) and a cross sectional view (FIG. 10F) of the assembled dripper in embodiments of the invention in which the dripper include an internal element being held from one side of the dripper;

FIG. 11 is a graph plotting a difference in percentage between a dripper with high discharge to a dripper with low discharge as a function of a field slope for inlet heads about 20, 30, 50, 100 and 150 cm, pipe length of about 150 m and pipe diameter of about 25 mm, as obtained in experiments performed according to some embodiments of the present invention;

FIG. 12A is a graph showing a relative discharge of 4 different drippers before and after flushing, as obtained in experiments performed according to some embodiments of the present invention;

FIG. 12B is a graph showing water discharge in a conduit during flushing as a function of a slope and an inlet pressure, for a conduit having a length of about 150 m and a diameter of about 25 m, as obtained in experiments performed according to some embodiments of the present invention;

FIGS. 13A-13C are graphs of the inlet pressure as a function of the conduit length for a slope of 0° (FIG. 13A), varying slope (FIG. 13B), and slope selected to ensure a uniform flow rate (FIG. 13C), as obtained in experiments performed according to some embodiments of the present invention;

FIG. 14 illustrates a type dripper which can be used according some embodiments of the invention;

FIGS. 15A and 15B illustrate another type of dripper which can be used according embodiments of the invention;

FIGS. 16A and 16B illustrate an additional type of dripper which can be used according to embodiments of the invention; and

FIGS. 17A-17F are schematic illustrations showing is perspective views of several the drippers shown in FIGS. 9A-9L, according to some embodiments of the present invention.

It is appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SPECIFIC EMBODIMENTS OF THE INVENTION

The present invention, in some embodiments thereof, relates to irrigation and, more particularly, but not exclusively, to method and system for irrigation at low water pressure.

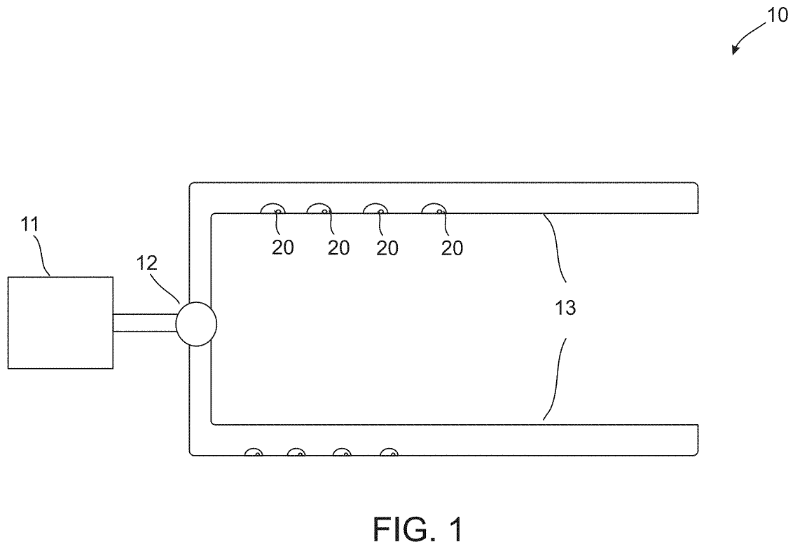

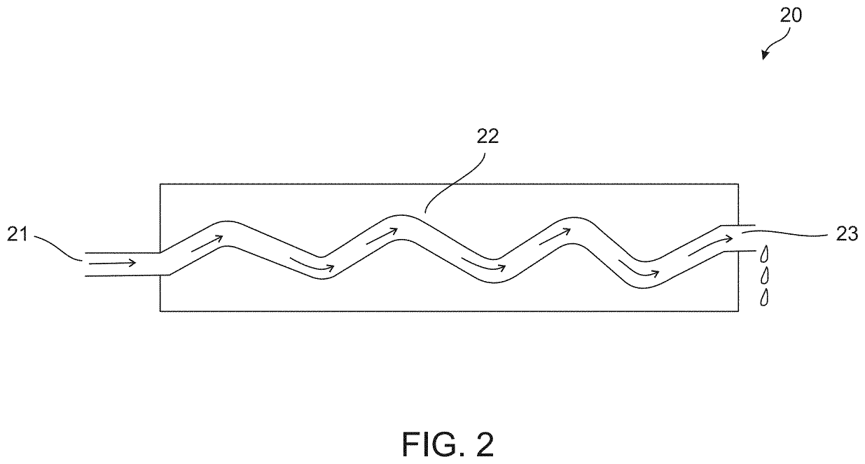

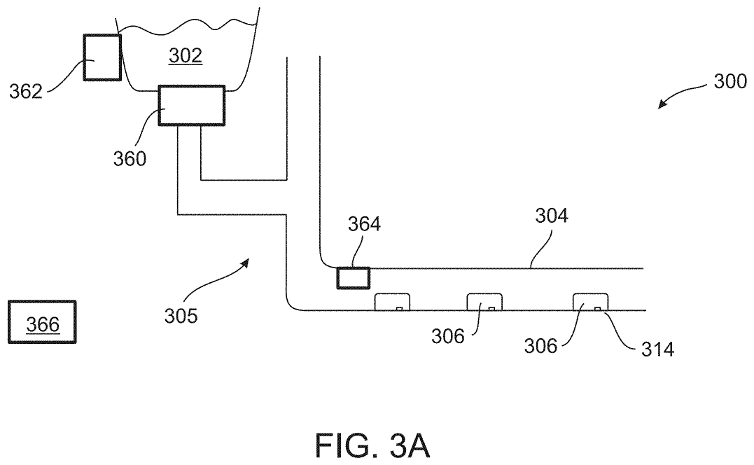

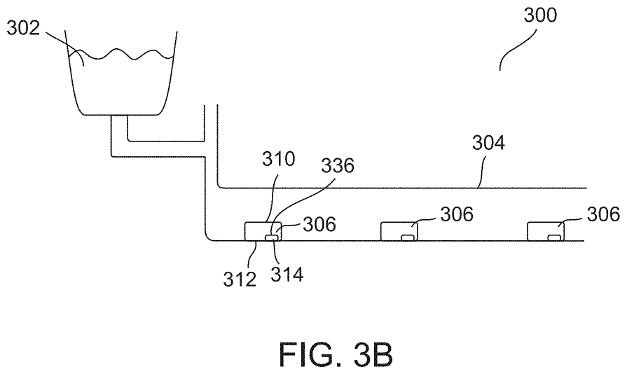

For purposes of better understanding some embodiments of the present invention, as illustrated in FIGS. 3A-17F of the drawings, reference is first made to the construction and operation of an irrigation system and a dripper as illustrated in FIGS. 1 and 2.

FIG. 1 illustrates an irrigation system 10 that includes a water supply 11, a pump 12 for pumping water from the water supply 11 to a plurality of conduits 13, thereby resulting in high-pressure water flow in the plurality of conduits 13. A plurality of drippers 20 is attached to the plurality of conduits 13, for decreasing the velocity of water flowing throughout the conduits 13 and for discharging the water to the ground at a controlled rate.

FIG. 2 illustrates a dripper 20 having a generally zigzag shaped water pathway 22, comprising alternately arranged protrusions, decreases the velocity of the water passing therethrough. Dripper 20 also includes a water inlet 21 through which water enters the dripper, and a water outlet 23 through which water flows out of the pathway to the ground. Dripper 20 also includes a filter (not shown), for preventing particles from entering dripper 20 and clogging it. The zigzag-shaped pathway 22 creates turbulence, which, in turn, causes energy loss. The energy loss is controlled by the structure and size of the water pathway 22.

The inventors found that traditional drippers may clog when particles accumulate therein, and that this requires constant supervision and inspection of the irrigation field and may increase the operating expenditure.

The inventors further found that reducing the operating pressure can reduce or eliminate the need for a pump, which, in turn, can reduce energy costs.

FIGS. 3A and 3B are schematic illustrations of an irrigation system 300, in accordance with some embodiments of the present invention. In various exemplary embodiments of the invention irrigation system 300 operates at a low water pressure, e.g., less than 0.1 bar, more preferably from about 5 mbar to about 90 mbar, more preferably from about 5 mbar to about 80 mbar, more preferably from about 5 mbar to about 70 mbar, more preferably from about 5 mbar to about 60 mbar, more preferably from about 5 mbar to about 50 mbar, more preferably from about 5 mbar to about 40 mbar e.g., 30 mbar. Irrigation system 300 optionally and preferably comprises a water supply system 302, which preferably supplies water at low pressure. Irrigation system 300 can also comprise an irrigation pipe 304 and one or more drippers 306. While FIGS. 3A and 3B show irrigation pipe 304 in a generally horizontal orientation, this need not necessarily be the case, since, in some preferred embodiments of the present invention, irrigation pipe 304 is inclined. System 302 can optionally and preferably be connected through a connector and/or valve 360, optionally and preferably to one or more of water distribution conduits 305. Alternatively or additionally, system 302 can be connected to one or more of a water reservoir, a water tank, a water container or a well.

In some embodiments of the present invention system 300 comprises a water pump 362 that delivers water to system 302 or water distribution conduits 305 or irrigation pipe 304, as desired. System 300 optionally and preferably comprises one or more pressure sensors 364 that measure water pressure in irrigation pipe 304. System 300 can further comprise a control system 366 for controlling the flow rate of the water supplied to irrigation pipe 304. Control system 366 can include a circuit that is configured to transmit control signals to pump 362 or connector and/or valve 360 thereby to control the flow rate in pipe 304. Optionally and preferably control system 366 receives sensing signals from sensors 364 and transmits the controls responsively to these sensing signals, so as to maintain the aforementioned water pressure in irrigation pipe 304.

Drippers 306 can be attached to, integrated in, or located in the interior of, irrigation pipe 304. In operation, drippers 306 discharge water through at least one water outlet 314, to provide a flow of water, for example, to soil, ground, or furrow. Outlet 314 of dripper 306 can optionally and preferably be adjacent to a hole 336 in pipe 304.

Irrigation pipe 304 can be made of any suitable material known in the art to operate normally to withstand pressure of at least 1 bars, to withstand accidental pressures as a result of loads generated, for example, by overridden wheels of a vehicle, and/or to withstand weather conditions, such as rain, or high temperatures typically caused from heat generated by the sun. For example, suitable materials may be polyethylene, polypropylene. polyvinylchloride and other thermoplastic materials. Typically, irrigation pipe 304 has a diameter of from about 20 mm and to about 40 mm, and length of from about 5 to about 300 m.

Drippers 306 are disposed along irrigation pipe 304. A typical distance between two adjacent drippers along pipe 304 is, without limitation, from about 20 to about 100 cm.

Drippers 306 can be embodied in more than one way. In the representative example shown in FIG. 3B, which is not to be considered as limiting, one or more, preferably each of, drippers 306 can be fixed on the inner wall of irrigation pipe 304, and may comprise one or more water inlet 312 through which the water enters the dripper 306, one water outlet 314 through which the water exits the dripper 306, and a water pathway 310 through which the water flows from the inlet 312 to the outlet 314. For example, a typical dripper 306 may include from about 1 to about 100 dripper inlets, and 1 dripper outlet.

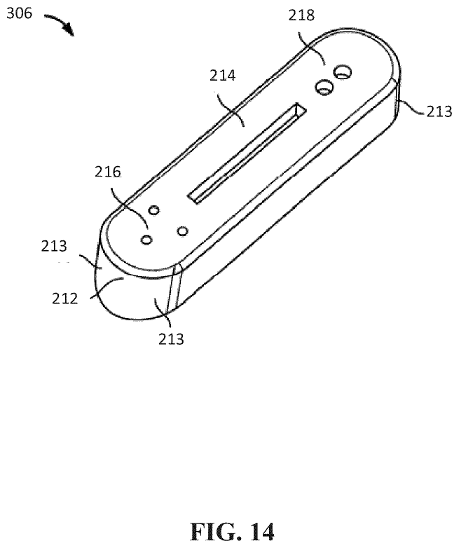

FIG. 14 illustrates dripper 306 according to another embodiment of the invention. In this embodiment, dripper 306 comprises a compact housing 212 made of a sturdy and non-corrosive material. The top surface 214 of dripper 306 defines two sets of inlets, each including one or more openings extending through the top surface 214. The inlets are exposed to the irrigation water flowing through the inside of the irrigation tube.

The first inlet 216 preferably includes three openings. Water flowing into the first inlet 216 proceeds through the body of dripper 306 to an outlet (not shown). In traveling through dripper 306 to the outlet, water pressure is reduced and water flow is reduced to a trickle or drip flow rate. The three openings are preferably sufficiently small in diameter to perform a filter function for water flowing through the first inlet 216, for example, to filter out debris or grit that might otherwise clog the interior of dripper 306. The openings making up the first inlet 216 are optionally and preferably spaced in a triangular pattern to allow water to uniformly impact interior surfaces of dripper 306. Although three equally spaced openings are shown in the preferred embodiment, other numbers and arrangements of openings may be utilized to form the first inlet 216.

The second inlet 218 preferably including two openings spaced along a center axis bisecting the length of dripper 306. Water flowing into the second inlet 218 optionally and preferably does not proceed through the body of dripper 306 but, instead, serves a pressure compensation function. Water flowing into the second inlet 218 accumulates in a chamber in the interior of dripper 306, applying pressure to the chamber in an amount substantially equivalent to the pressure in the irrigation tube. Because water flowing through the second inlet 218 does not flow through dripper 306, the openings of the second inlet 218 need not filter the inflowing water and the openings need not be small in diameter. Although two openings are shown in the preferred embodiment, as seen in FIG. 14, other numbers and arrangements of openings may be utilized to form the second inlet 218.

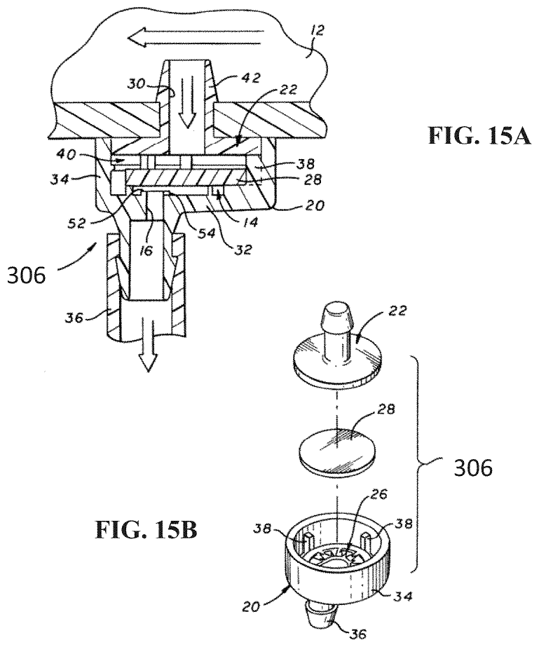

FIGS. 15A and 15B illustrate dripper 306 according to another embodiment of the invention. In this embodiment, dripper 306 comprises a compact housing which can be conveniently and economically formed from assembled plastic molded housing components. The housing includes a generally cup-shaped base 20 adapted for assembly with a cap 22 to form a substantially enclosed housing interior. In general terms, the flow channel 14 is defined by a channel pattern 26 formed in the base 20, in cooperative relation with a resilient and flexible elastomeric valve member 28. Water is supplied to the flow channel 14 via a water inlet 30 formed by the cap 22, and water is discharged from the flow channel through the discharge outlet 16 formed in the base 20. The geometry of the channel pattern 26 cooperates with the valve member 28 to define the three dimensional flow channel 14 for improved pressure drop between the inlet 30 and the outlet 16.

Housing base 20 has an upwardly open, generally cup-shaped construction including a circular bottom or floor surface 32 joined at the perimeter thereof to a cylindrical upstanding outer wall 34. The channel pattern 26 is formed on the floor 32 with a generally circular configuration arranged about the outlet 16 which may include a short downwardly projecting hollow stem 36 for press-fit attachment to discharge tubing (not shown), if desired. A plurality of spacer posts 38 are also formed on the base 20 to project upwardly from the floor 32 at the floor perimeter and terminate with upper ends disposed above the channel pattern 26, but below the upper edge of the outer wall 32.

The valve member 28 comprises a resilient disk having a size and shape to fit into the housing base 20, with an outer margin of the valve member 28 fitting within the spacer posts 38. The housing cap 22 is then assembled with the base 20 by press-fit mounting of the disk-shaped cap into the open end of the base, to seat the cap 22 against the upper ends of the spacer posts 38. The cap 22 can be securely connected to the base 20 in a sealed manner by use of a suitable adhesive, or by ultrasonic welding or the like. When assembled, the housing base 20 and cap 22 defined an inlet chamber 40 (FIG. 15A) within which the valve member 28 is retained with at least some floating movement in a position aligned over the channel pattern 26. The water inlet 30 is formed in the cap 22 and is typically associated with an inlet stem 42 which may include a barbed construction for press-on puncture type attachment to the water supply hose 12.

From flow channel 14, the water enters the centrally located discharge chamber having a raised circular boss 52 projecting upwardly from the floor 32 of the housing base 20 to engage the valve member 28. The boss 52 has an upwardly open discharge regulating groove 54 formed therein, for discharge flow of the water from the outlet chamber to the water outlet 16.

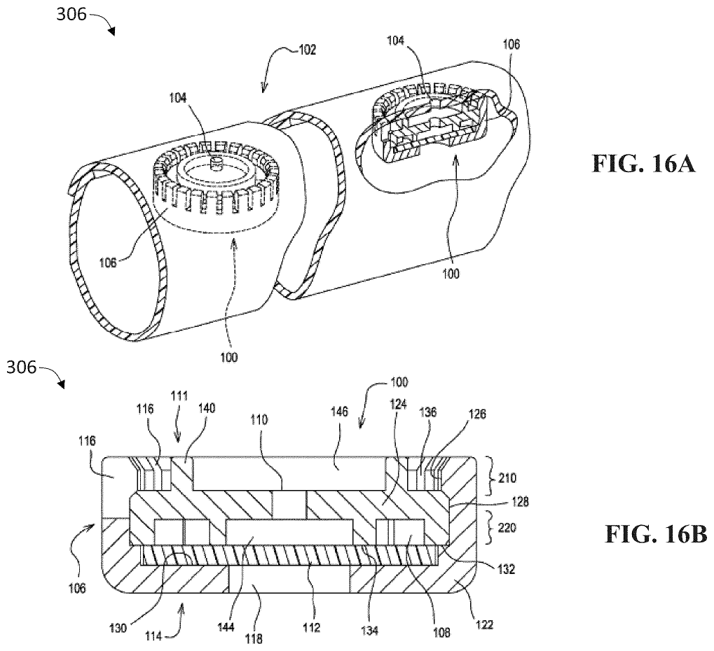

FIGS. 16A and 16B illustrate dripper 306 according to another embodiment of the invention. The dripper 306 may be a molded plastic body that may be inserted into thin walled drip tape 102, or any other type of water conduit such as an extruded hose, at regularly spaced intervals during or immediately following extrusion of the drip tape. Each dripper 306 may have a single outlet that may be positioned at an opening 104 that is cut or pre-formed in the wall of the drip tape during production. Water in thin walled drip tape 102 may enter the dripper 306 by passing through a filter at the dripper's sides or perimeter 106. Because the filter area is in the dripper's sides or perimeter, the dripper 306 can provide a filter of large area relative to the size or thickness of the dripper 306. For example, the dripper 306 in a preferred embodiment may have a thickness of about 3.5 mm, and a filter area of at least about 12 mm².

In one embodiment, filtered water then passes through labyrinth 108 where water pressure is reduced. For example, water pressure may be reduced from the line pressure in the drip tape (e.g., 12 psi) to a substantially lower pressure. Water at the reduced pressure then may flow through outlet hole 110 near the dripper's first or outer face 111 welded or adhered to the drip tape wall.

In one embodiment, the dripper 306 is pressure regulated using diaphragm 112 at or adjacent the dripper's second or inner face 114. Water pressure in the drip tape acts against the diaphragm to regulate the dripper's flow rate as water pressure changes within the water conduit.

Dripper 306 may include three parts, two body members 122 and 124, and elastomeric diaphragm 112. The dripper's first or outer face 111 may have one or more walls or surfaces that are welded, adhered to or otherwise bonded to the drip tape inner wall. The dripper 306 has a second or inner face 114 that may project inwardly toward the interior of the drip tape. The thickness of the dripper 306 between the first or outer face and the second or inner face is preferably less than about 5 mm, and most preferably less than about 3.5 mm. The filter area of the dripper 306 is entirely on the sides 106 or periphery of the dripper 306, between the dripper's outer face 111 and inner face 114.

In one embodiment, the filter area may be configured as a plurality of slots 116 through the sides of the dripper 306 which provide filtering inlets or passages for water in the drip tape to enter into the dripper 306. Each slot 116 through the dripper's side walls may have dimensions that are small enough to block particles or debris from passing through the slot to the interior of the dripper 306, while allowing a desired flow rate of water from the drip line into the interior of the dripper 306.

For example, in one embodiment, the dripper 306 may be generally disc shaped, and each slot 116 may extend radially through the dripper's cylindrical side walls 106, from the perimeter or outer surface to the interior of the dripper 306. Dripper 306 may have 24 radial slots, each slot having a width of less than about 0.5 mm, and most preferably having a width of less than about 0.3 mm. The radial thickness of the dripper's side walls may be between about 0.5 mm and about 1.0 mm. The dripper's radius may be between about 3.5 mm and about 6.5 mm, and the dripper's outer circumference may be between about 10 mm and about 30 mm.

In one embodiment, the second or inner face 114 of the dripper 306 may have an opening 118. Diaphragm 112 may be an elastic bladder that is positioned between body members 122 and 124, while the diaphragm is directly exposed on one side to the water pressure within the drip tape or other water conduit where the dripper 306 is mounted. For example, the diaphragm may have a thickness of about 0.5 mm to about 0.75 mm, and a surface which is large enough to cover both pressure regulating chamber 144 and labyrinth 108 which is formed in second body member 124 on surface 132.

In one embodiment, the diaphragm may be exposed to line pressure in the drip tape which may enter through opening 118 and directly act against the diaphragm, causing the diaphragm to flex as the water pressure at the diaphragm on the other side is decreased. If water pressure in the drip tape increases, the diaphragm may flex radially toward outlet 110 and away from the dripper's second or inner face, reducing the outlet flow from the dripper 306.

In one embodiment, water acting against the diaphragm while passing through opening 118 does not also pass through a filter. Instead, the filter may be an array of slots 116 in the dripper's cylindrical side walls 106, and are dedicated only for water entering the dripper's pressure reducing area, or labyrinth 108.

In one embodiment, diaphragm 112 may be held in place by sandwiching outer portions of the diaphragm between first body member 122 and second body member 124 of the dripper 306. The first and second body members may be engaged together with a snap or press fit. For example, the second member may be inserted into the first member, and may be held in place by shoulders 126 that extend inwardly from the dripper's side walls 106. The inwardly facing shoulders may capture and hold the second member in place because the dimensions of the second member's outer rim or perimeter 128 may be slightly larger than the dimensions of shoulders 126. Diaphragm 112 may be held between surface 130 of the first member and one or more walls 132, 134 of the second member. Optionally, the shoulders and outer rim or perimeter may be tapered to facilitate ease of assembly. Additionally, portions of the diaphragm that are radially outside of opening 118 may be compressed axially by a tight or sealing interfit between the first and second body members.

In one embodiment, water entering the dripper 306 through the filter area in the dripper's sides may be collected in manifold flow channel 136 inside the filter area. For example, the manifold flow channel may be a passage radially within the filter area on the dripper's side walls 106, and may be enclosed by the drip tape wall, surface 138, and wall 140 that circumscribe exit pool 146.

In various exemplary embodiments of the invention irrigation pipe 304 is arranged to compensate pressure losses in the drippers along the irrigation pipe. In operation, water supply system 302 delivers water to pipe 304, optionally and preferably at a highest level of pipe 304.

It was found by the Inventors that this results in a generally high water flow rate, and also maintains a generally uniform flow rate in all drippers 306.

In some embodiments of the present invention control system 366 ensures that water supply system 302 delivers the water to pipe 304 at a pressure of at most about 90 cm H₂O (e.g., from about 5 cm to about 90 cm H₂O), or at most 80 cm H₂O (e.g., from about 5 cm to about 80 cm H₂O), or at most 70 cm H₂O (e.g., from about 5 cm to about 70 cm H₂O), or at most 60 cm H₂O (e.g., from about 5 cm to about 60 cm H₂O), or at most 50 cm H₂O (e.g., from about 5 cm to about 50 cm H₂O), and further or at most 40 cm H₂O (e.g., from about 5 cm to about 40 cm H₂O). For example, when supply system 302 is a pump and/or comprises a controllable valve (not shown), control system 366 can controls the pump or valve to deliver the preferred pressure. Alternatively, water supply system 302 can be configured to the deliver the water at the aforementioned pressure without a control system (e.g., by a judicious selection of the outlet diameter and/or pressure within the water supply system 302).

Drip irrigation systems involve investment costs and power consumption in high pressure (energy) and filtration systems to work efficiently. Surface irrigation systems typically employ high discharge at a water inlet in order to irrigate efficiently and uniformly using surface irrigation so that water will reach an end of the field. It was found by the inventors of the present invention that reduction of water amount by a steeper slope field may cause runoff, erosion and soil degradation.

Drip irrigation systems provide higher water uniformity across a field than surface irrigation due to reduced runoff and leaching, however, it was realized by the inventors of the present invention that the high pressure requirement causes high energy costs and high investment costs in filters, pumps, pressure regulators, and materials of irrigation pipe that can withstand high pressure. It was realized by the inventors of the present invention that drip irrigation systems that work at pressures between 0.05 to 0.1 bar and cannot be applied in large commercial fields. A criterion for discharge variation in an irrigated field is typically 10% or less.

The inventors found that an irrigation system comprising an irrigation pipe that may be inclined at a varying slope, may be selected such that a water discharge along a length of the inclined irrigation pipe varies by no more than about 20%, or no more than 18%, or no more than 16%, or no more than 15%, or no more than 13%, or no more than 12%, or no more than 10%.

As used herein, “water discharge” refers to a volume of water that exits the dripper per unit time.

In some embodiments of the present invention irrigation pipe 304 is inclined at a gradually varying slope, and in some embodiments of the present invention irrigation pipe 304 is inclined at a slope that varies non-continuously.

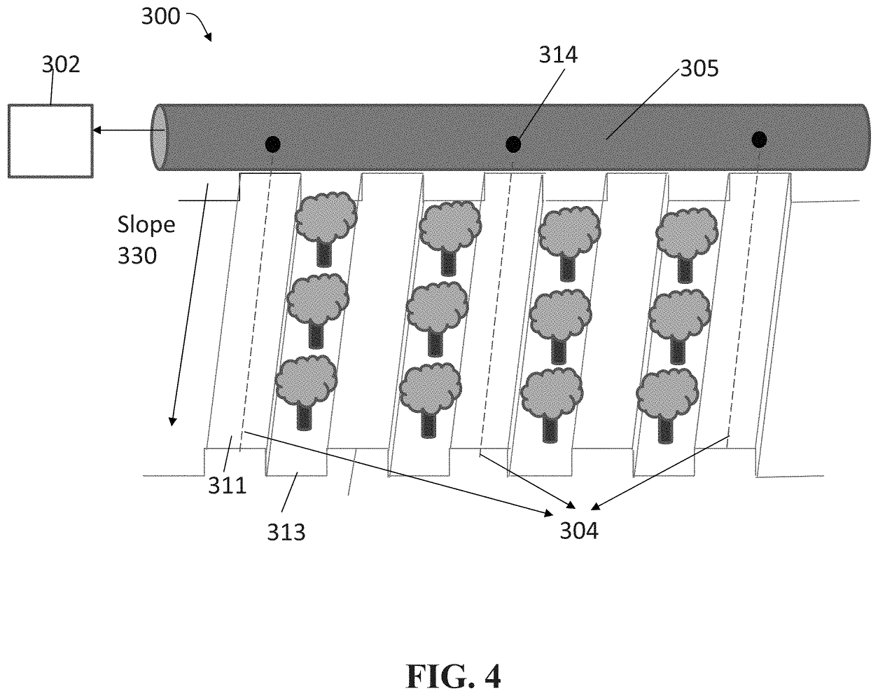

FIG. 4 is a schematic illustration of irrigation system 300, in embodiments of the invention in which a varying slope is employed. Irrigation system 300 can comprise water supply system 302, one or more inclined irrigation pipe 304 and a plurality of drippers 306 (not shown, see, e.g., FIGS. 3A and 3B). In the representative illustration of FIG. 4, which is not to be considered as limiting, the irrigation system 300 comprises a distribution conduit 305 into which water is discharged from system 302. Conduit 305 is provided with holes 314 to which irrigation pipes 304 are connected with suitable connectors (not shown). The irrigation pipes 304 are optionally and preferably placed between furrows 311 that are typically used for flooding and are arranged in a slope 330 for compensating in losses in flow along the irrigation pipes 304. Slope 330 can vary (gradually or non-continuously) along the irrigation pipes 304.

For example, irrigation pipe 304 may be inclined at a gradually varying slope with a higher slope (in absolute value) at the beginning of the irrigation pipe 304 and a lower slope (in absolute value) at one or more location downstream pipe 304. It was found by the Inventors that this can increase the water flow rate, and can maintain a generally uniform pressure in all drippers 306. In some embodiments of the present invention irrigation pipe 304 is inclined at a gradually varying slope that is selected such that a water discharge along a length of pipe 304 varies by no more than about 20%, or no more than 18%, or no more than 16%, or no more than 15%, or no more than 13%, or no more than 12%, or no more than 10%.

The varying slope is optionally and preferably selected such that for at least one pair of drippers in pipe 304, more preferably for at least two pairs of drippers in pipe 304, more preferably for at least three pairs of drippers in pipe 304, more preferably for any pair of drippers in pipe 304, the ratio between the slope Si at a location of one of drippers of the pair and the slope S₂ at a location of another one of the drippers of the pair, is equal or approximately equal to the nth power of the ratio between the distances of the drippers from the lowermost point of pipe 304 (e.g., the farthest point of pipe 304 from conduit 305). Mathematically, this can be expressed as S₁/S₂∝[(L−l₁)/(L−L₂)]ⁿ, where L is the length of pipe 304, l₁ is the distance between the highest point along pipe 304 and one of drippers of the pair, and l₂ is the distance between the highest point along pipe 304 and the other dripper of the pair. The value of the exponent n is preferably from about 1.5 to about 4.5, e.g., about 2 or about 3.

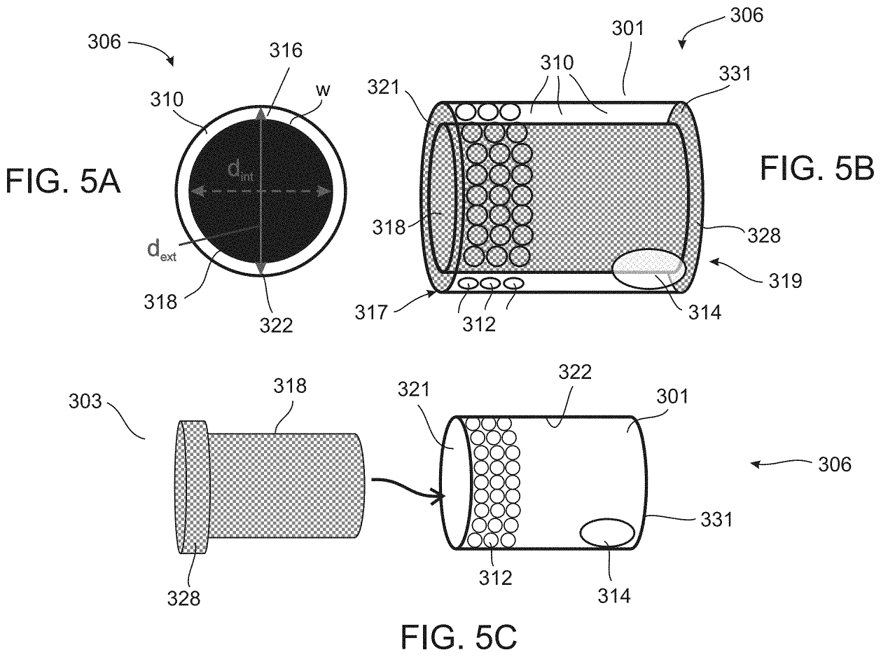

Reference is made to FIGS. 5A-5C which are schematic illustrations of a dripper 306, according to some embodiments of the present invention. Dripper 306 optionally and preferably comprises a plurality of holes functioning as water inlets 312. However, this need necessarily be the case, since, for some applications, the end of the dripper can serves as an inlet. Dripper 306 can be useful in irrigation systems such as, but not limited to, the irrigation systems illustrated above with reference to FIGS. 3A, 3B and FIG. 4. Dripper 306 can be attached to, or located in, one or more irrigation pipes 304. Dripper 306 can be integrated into irrigation pipes 304 during pipe manufacturing process.

In the representative illustration of FIG. 5A, dripper 306 is assembled from an external hollow element 301, e.g., in a shape of a hollow tube; and having one or more water inlets 312 for intaking water into dripper 306, and one or more water outlets 314 for discharging water from the dripper 306. Dripper 306 also comprises an internal element 303 having a diameter that is smaller than the diameter of the external hollow element 301, such that when the internal element 303 is inserted inside external hollow element 301, a water pathway 310 is formed in a space therebetween. Pathway 310 can extend from one end 321 of dripper 306 to another end 331 of dripper 306. End 331 is optionally and preferably closed. In various exemplary embodiments of the invention water pathway 310 is formed such that there is at least one inlet-outlet pair that is connected by a straight line that is within water pathway 310. This allows at least a portion of the water to flow along a straight line from one or more of the inlet(s) 312 to one or more of the outlet(s) outlet 314, and is unlike drippers having, for example, zig-zag or labyrinth pathways.

Herein “an inlet-outlet pair” is a pair that includes one of inlet(s) 312 and one of outlet(s) 314.

Water inlets 312 can be in the form of a plurality of small cavities having a diameter from about 0.05 mm to about 1 cm and inter-inlet intervals of from about 0.01 mm to about 1 cm. Water outlets 314 are preferably configured to discharge water from the dripper to provide a desired discharge flow rate of water out from the dripper to the soil or ground. The hole diameter of the water outlets 314 is typically from about 0.5 mm to about 2 mm. Water outlets 314 of dripper 306 can optionally and preferably be in communication with a hole 336 (shown in FIG. 3B) located in the inclined irrigation pipe 336 (shown in FIG. 3B).

According to some embodiments of the invention dripper 306 is characterized by a pressure-discharge dependence which comprises a linear relation between a discharge rate Q (water volume per unit time) at outlet 314 and an inlet pressure P at inlet 312. This relation can be expressed mathematically as Q=a₁P+a₀, where a₁ is an inlet pressure coefficient and a₀ is an offset parameter. A typical value for a₁ is from about 7 cubic centimeters per hour per cm H₂O to about 40 cubic centimeters per hour per cm H₂O or from about 7 cubic centimeters per hour per cm H₂O to about 20 cubic centimeters per hour per cm H₂O or from about 9 cubic centimeters per hour per cm H₂O to about 12 cubic centimeters per hour per cm H₂O. A typical value for a₂ is from about 0 to about 50 cubic centimeters per hour, or from about 10 cubic centimeters per hour to about 40 centimeters per hour, or from about 20 cubic centimeters per hour to about 30 cubic centimeters per hour.

FIG. 5B illustrates a longitudinal cross-sectional illustration of dripper 306, according to some embodiments of the present invention, and FIG. 5C illustrates an exploded side view of external hollow element 301 (right side) and internal element 303 (left side), according to some embodiments of the present invention.

The dripper 306 may comprise an external hollow element 301 having a first end 331, which may be closed. Internal element 318, with a head 328, may be inserted into the external hollow element 301. Head 328 of internal element 303 preferably closes one end 321 of external hollow element 301 after these elements are assembled together. External hollow element 301 can have a plurality of water inlets 312 at one end 317 and one or more water outlets 314 at the other end 319.

With reference to FIG. 5A, an internal diameter dᵢₙₜ is typically defined between the two farthest antipodal points on an outer wall 318 of internal element 303. An external diameter dₑₓₜ is typically defined between the two farthest antipodal points on an inner wall 322 of external hollow element 301. When the internal element 303 is introduced into the external hollow element 301, a water pathway 310 is created having a width W. The width W is optionally and preferably be set to provide a sufficiently narrow water pathway 310 and to provide a small hydraulic diameter (D_{H}) for reducing flow within the dripper 306.

The hydraulic diameter (D_{H}) is a parameter that is defined as four times the ratio between a flow area A and a wetted perimeter of a conduit, P, as defined in Equation I:

Dₙ=4A/P (EQ. I)

In EQ. IA can be the cross-sectional area of the water pathway 310 in dripper 306 and P can be the wetted perimeter of the cross-section, in which case D_{H} is referred to as the hydraulic diameter of pathway 310.

For example, when water pathway 310 has a circular shape, the hydraulic diameter according to EQ. I above is reduced to the diameter of the circle forming the pathway.

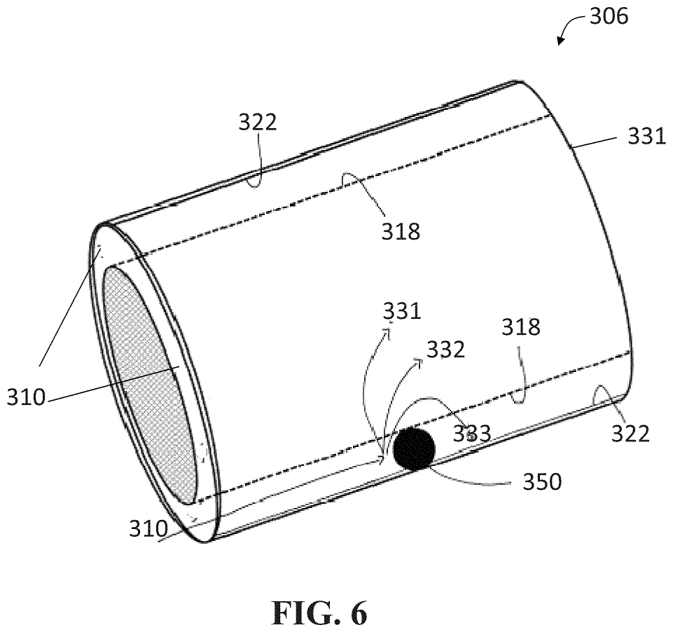

A typical hydraulic diameter of pathway 310, suitable for the present embodiments is from about 50 μm to about 500 μm. Other values for hydraulic diameter are also contemplated, provided that clogging within the water pathway 310 is reduced or inhibited, as further discussed hereinbelow with reference to FIG. 6.

When water pathway 310 has an annulus shape, the hydraulic diameter is defined as the width W of the pathway, which can be calculated as the difference between the internal diameter d₅₀₁ of external hollow element 301, and the external diameter d₅₀₈ of internal element 303, according to EQ. II:

D_{H}=W=d₃₀₁−d₃₀₃ (EQ. II)

It is appreciated that the water flow rate decreases in a channel as its hydraulic diameter decreases.

The Inventors of the present invention found that by utilizing a narrow hydraulic diameter dripper according to preferred embodiments of the present invention, particular at a low operating pressure, may provide a low discharge flow rate when exiting from dripper 306. Small hydraulic diameter may be achieved by providing a sufficiently large relative surface area of the narrow water pathway 310, and/or by reducing the energy of water flowing in the water pathway 310, for example, by increasing friction for water flow of the narrow water pathway 310 of the dripper 306. An enlarged relative surface area of water pathway 310 can be achieved, for example, by making shaped pathway. For example, the pathway can be shaped as a polygon (e.g., a triangle, a square, etc). An enlarged relative surface area of water pathway 310 can alternatively or additionally be achieved by providing a sufficiently long pathway between the inlet 312 and outlet 314.

Particle accumulation at the dripper entrance can cause clogging and reduced flow discharge, thus resulting in flow discharge decrease or no flow.

The advantage of having a pathway as described above can be better understood with reference to FIG. 6 which illustrates a perspective side view of dripper 306 according to some embodiments of the present invention. Shown is an obstacle 350, such as a particle or an air bubble, in its water pathway 310, which, in the illustrated embodiment, has an annulus shape. Obstacle 350 can be in contact with inner wall 322 of external hollow element 301 and outer wall 318 of internal element 303 of dripper 306, thereby partially or even completely clogging a region pathway 310. However, since pathway 310 is not one-dimensional, there are other alternative paths within pathway 310 allowing bypass routes 331, 332 and 333 around any obstacle that may be inside dripper 306. Moreover, the amount of particles entering the dripper may be reduced by providing dripper 306 with a narrow entrance. Water inlets 304 may be of a size of from about 50μm to about 500 μm. Thus, pathway 310 is not completely blocked by obstacle 350.

In some embodiments of the present invention there are multiple capillary water inlets 312. Typically, but not necessarily, for example, between 1 and 100 capillary water inlets are employed. The advantage of having a multiplicity of capillary water inlets is that the capillary water inlets can serve as a filter for dripper 306, and reduce the risk of dripper clogging.

According to some embodiments of the present invention, the hydraulic diameter D_{H} is from about 0.01 to about 1 mm. According to some embodiments of the present invention the external hollow element 301 has an inner diameter of from about 0.5 mm to about 5 mm.

Cross-sectional area of the dripper suitable for the present embodiments can be from about 3 mm² to about 300 mm², depending on the width of water pathway 310. The water flow rate of water flowing through dripper 306, is typically from about 100 ml/h to about 10,000 ml/h at a hydraulic pressure of from about 0.1 m H₂O to about 2 m H₂O. For example, a dripper of about 3 cm in length and an annulus about 100 μm in width can produce a flow rate of about 1400 ml/h at a pressure of 1.5 m H₂O.

The outer surfaces of external 301 and internal 303 elements may be parallel to each other up to a tolerance of about 10%. The distance between water inlets 312 can be from about 0.5 to about 2 mm. The distance between water inlets 312 and water outlets 314 can be from about 1 to about 6 cm.

As may further be appreciated, irrigation system 300, by employing the drippers of the present embodiments, and operating them at a low pressure may eliminate a need for pump 12 of the kind displayed in FIG. 1, and as a result, irrigation pipes 304 of the present embodiments may be made of fewer and cheaper raw materials.

In addition, the Inventors found the dripper of the present embodiments allows particles to be washed out by water flowing inside. Even if particles are partially clogged within the dripper of the present embodiments, the partial clogging may unclog when clean water is provided to the dripper, by washing the particle away. As a result, the dripper of the present embodiments has natural, built-in, self-cleaning capabilities.

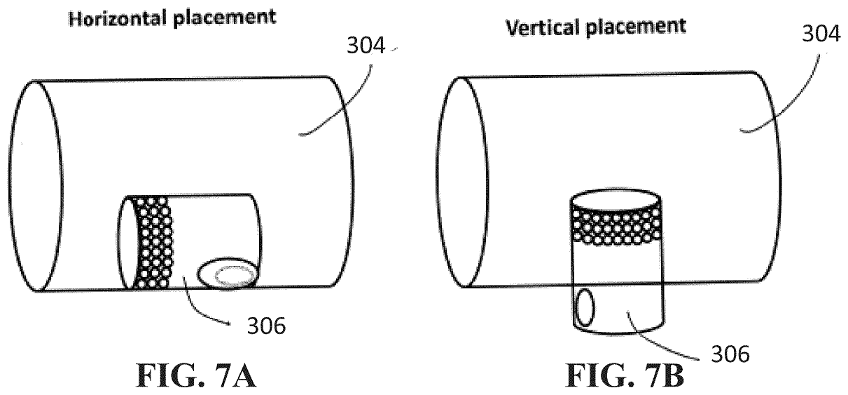

With reference now to FIGS. 7A and 7B, the plurality of drippers 306 in any one of the embodiments of the irrigation system described above can be positioned either horizontally or vertically relative to the position of the irrigation pipe 304, as illustrated in FIG. 7A and FIG. 7B, respectively.

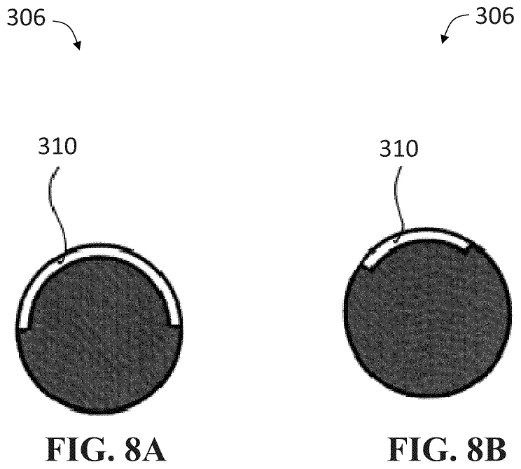

FIGS. 8A and 8B are cross-sectional illustrations of partial water pathway inside a dripper 306, according to some embodiments of the present invention.

As described hereinabove in FIGS. 5A-5C, water pathway 310 is created by assembling the internal element 303 with the external hollow element 301. Internal element 303 may have alternative cross-sections such by utilizing the water pathway 310 in a shape of a partial ring, namely, by partially utilizing at least a portion of the annulus 310. Any of the components of dripper 306 may comprise molded plastic. Internal element 303 may be inserted into external hollow element 301.

In some embodiments of the present invention one or more covers may be put on one or more sides of external hollow element 301, thereby closing one or more of its ends.

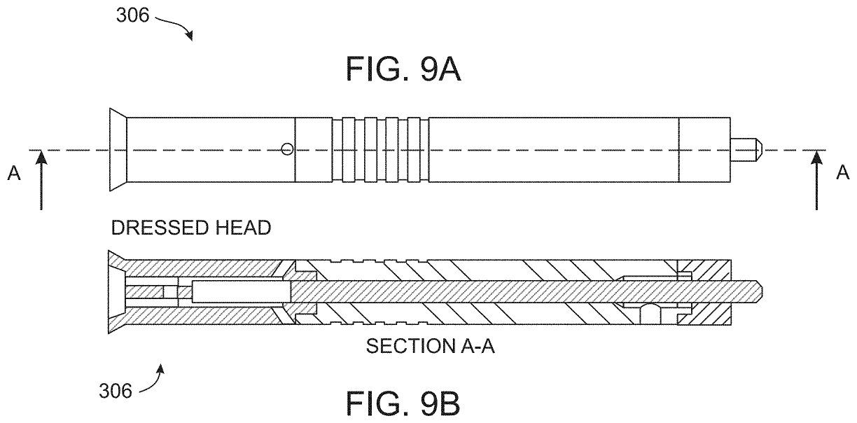

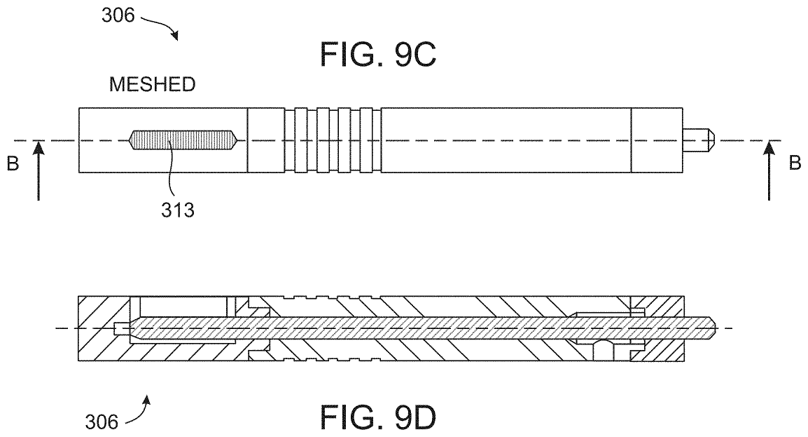

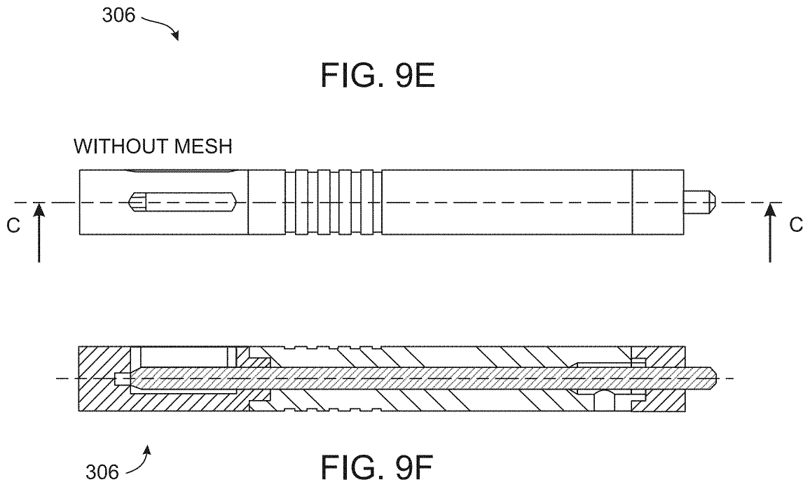

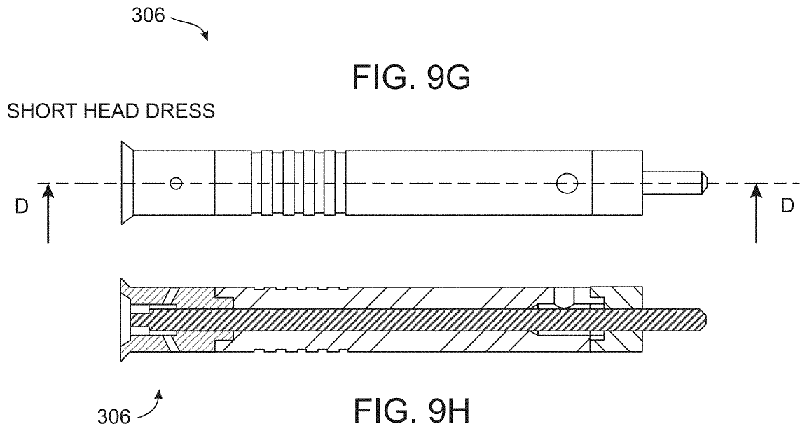

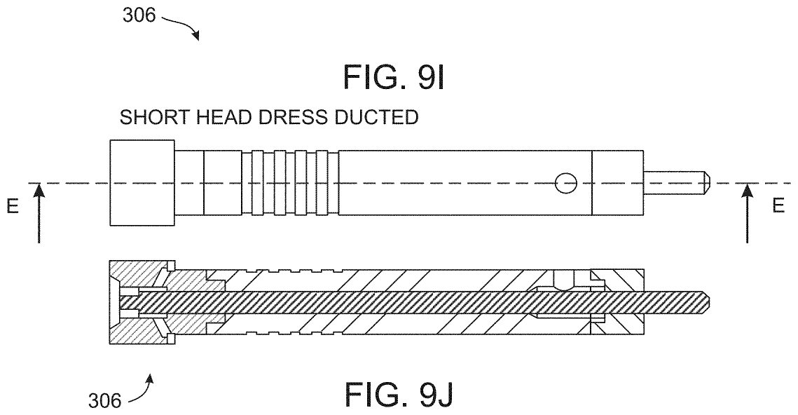

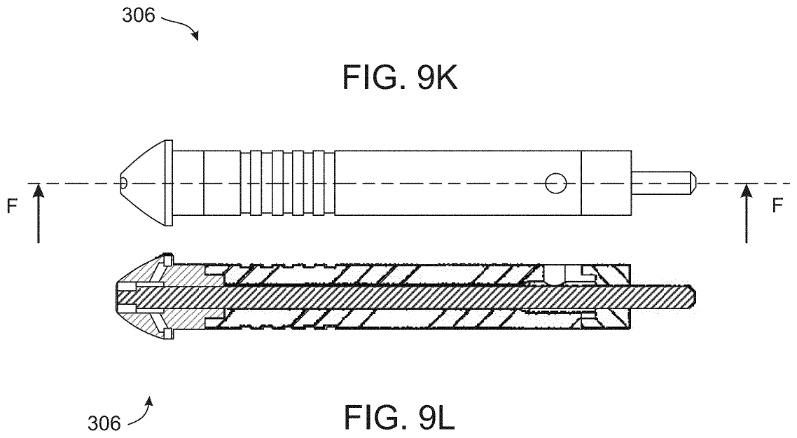

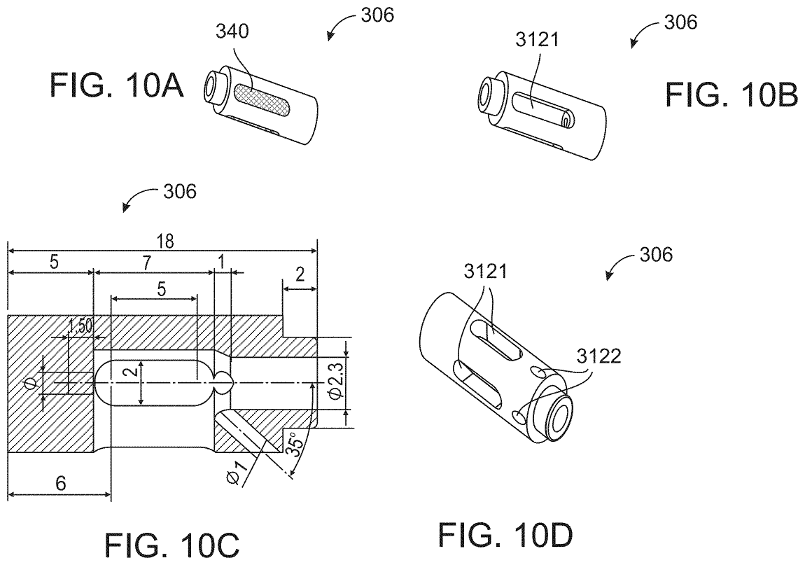

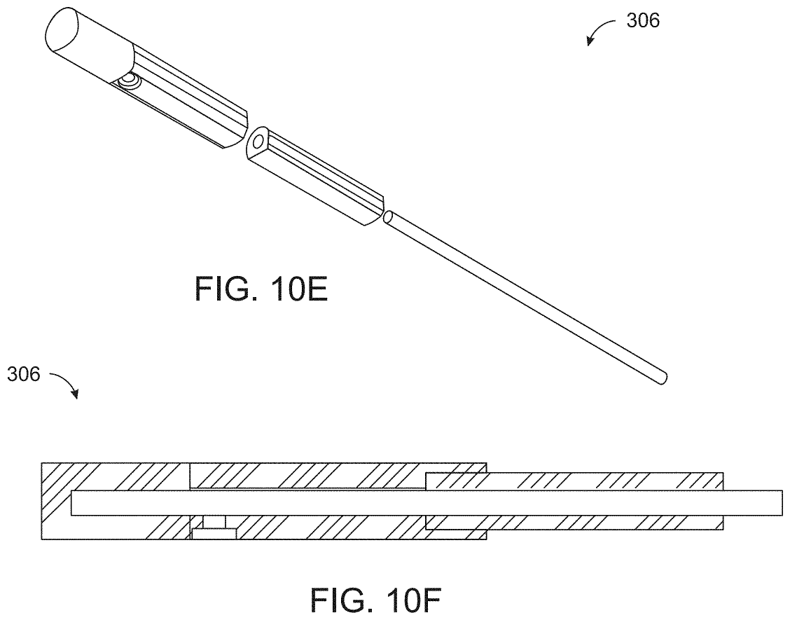

FIGS. 9A-9L are schematic illustrations showing cross-sectional views of dripper 306, according to several embodiments of the present invention. FIGS. 9A and 9B illustrate a side view (FIG. 9A) and a sectional view along the A-A line (FIG. 9B) of dripper 306 in embodiments in which dripper 306 comprises diagonal holes in the sides and exit holes under a dressed head (the left side is not shown in the drawing). FIGS. 9C and 9D illustrate a side view (FIG. 9C) and a sectional view along the B-B line (FIG. 9D) of dripper 306 in embodiments in which dripper 306 comprises elliptically shaped water inlet (see also FIG. 10A, below) with a filter 313. FIGS. 9E and 9F illustrate a side view (FIG. 9E) and a sectional view along the C-C line (FIG. 9F) of dripper 306 in embodiments in which dripper 306 comprises an elliptically shaped water inlet without a filter (see also FIG. 10B, below). FIGS. 9G and 9H illustrate a side view (FIG. 9G) and a sectional view along the D-D line (FIG. 9H) of dripper 306 in embodiments which are similar to those shown in FIGS. 9A and 9B, except for a shorter distance between the dripper's end and the exit holes. FIGS. 9I and 9J illustrate a side view (FIG. 9I) and a sectional view along the E-E line (FIG. 9J) of dripper 306 in embodiments in which are similar to those shown in FIGS. 9C and 9D, except that dripper 306 comprises diagonal holes under a cover. FIGS. 9K and 9L illustrate a side view (FIG. 9K) and a sectional view along the F-F line (FIG. 9L) of dripper 306 in embodiments in which are similar to those shown in FIGS. 9C and 9D, except that the outer shape is tapered to reduce friction.

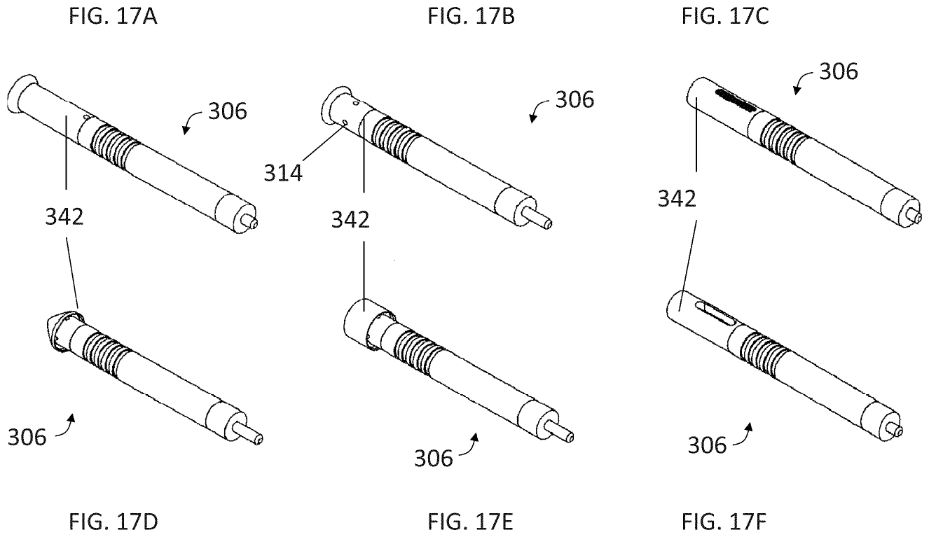

Perspective illustrations of the drippers illustrated in FIGS. 9A-9L are shown in FIGS. 17A-17F, where FIG. 17A corresponds to FIGS. 9A and 9B, FIG. 17C corresponds to FIGS. 9C and 9D, FIG. 17F corresponds to FIGS. 9E and 9F, FIG. 17B corresponds to FIGS. 9G and 9H, FIG. 17E corresponds to FIGS. 9I and 9J, and FIG. 17D corresponds to FIGS. 9K and 9L. The cover on external hollow element 301 is shown in FIGS. 17A-17F at 342.

The length of external hollow element 301 and internal element 303 may be between about 20 and 50 mm. The diameter of external hollow element 301 may be between about 1 and 10 mm, and the diameter of internal element 303 may be between about 0.5 and 9.7 mm. The size of inlet 312 and outlet 314 may be between about 0.5 and 5 mm. The height of “baths” 346 may be between about 100 and 500 micron larger than narrow space 310 and the width of narrow space 310 may be between about 50 and 400 micron.

It will be appreciated that although the drippers and their components that were described herein have a cylindrical shape, they may also be manufactured in other shapes such that the external hollow element and the internal element described herein may be in any shape or form, such as, ellipse, square, rectangular, triangular, hexagonal, octagonal, etc.

Alternatively or additionally, the dripper according to the present embodiments may have an elliptically shaped water inlet, or a plurality of such shaped inlets. Alternatively or additionally, the dripper according to the present embodiments may have a water inlet having any geometric shape, such as square, rectangle, triangle and circle.

With reference to FIG. 10A, there is illustrated a perspective side view of an assembled dripper 306 having an elliptically shaped water inlet 3121 according to some embodiments of the present embodiments. As shown, the water inlet is positioned perpendicular to the drip.

Reference is now made to FIG. 10B, which displays a perspective side view of an assembled dripper 306 having an elliptically shaped water inlet 3121 and comprising a filter according to some embodiments of the present embodiments. The elliptical water inlet 3121 (or a plurality of such inlets) comprises a filter 340 in various possible shapes (grid, cross-sectional or longitudinal grooves). As shown, the water inlets 3121 are positioned perpendicular to the drip 306.

In addition to the vertical elliptical inlet 3121 as displayed in FIGS. 10A and 10B, there are additional inlets, which are not vertical to the drip 306, through which water enters when their flow direction is generally at an obtuse angle θ to the flow of water in the drip. Typical values of θ include, without limitation, from about 110° to about 155°, or from about 120° to about 145°, or from about 130° to about 145°, e.g., about 135°. FIGS. 10C and 10D illustrate a cross sectional view (FIG. 10C) and a perspective side view (FIG. 10D) of an assembled dripper having an elliptically shaped water inlet 3121 and an additional water inlet 3122 oriented diagonally with respect to a normal to an outer surface of an external hollow element 301 according to some embodiments of the present embodiments.

The inlets reach a level where water enters the drip and creates turbulence that prevents particles from accumulating in the water entry area. The drip water entry area is the area where particles may accumulate and may cause a partial or complete blockage of the drip, such that if particles have been introduced into the drip 306, then the particles may not accumulate and may exit through the outlet as a result of the dripper's three-dimensional shape and smoothness. The water inlets 3122 may be oriented in a diagonal position with respect to a normal to an outer surface of the external hollow element 301, which may produce turbulent flow of water in entry to the dripper inlet.

FIGS. 10E and 10F are schematic illustrations showing a perspective view (FIG. 10E) and a cross sectional view (FIG. 10F) of the assembled dripper in embodiments of the invention in which the internal element is held only from one side.

As described herein above, it was realized by the inventors of the present invention that drip irrigation systems work at pressures between 0.5 to 4 bar and cannot be applied in large commercial fields using a work pressure lower than 0.1 bar. The inventors devised an irrigation system having an irrigation pipe inclined at a slope that can be selected such that a water discharge along a length of the pipe varies by no more than 20%, or no more than 18%, or no more than 16%, or no more than 15%, or no more than 13%, or no more than 12%, or no more than 10%.

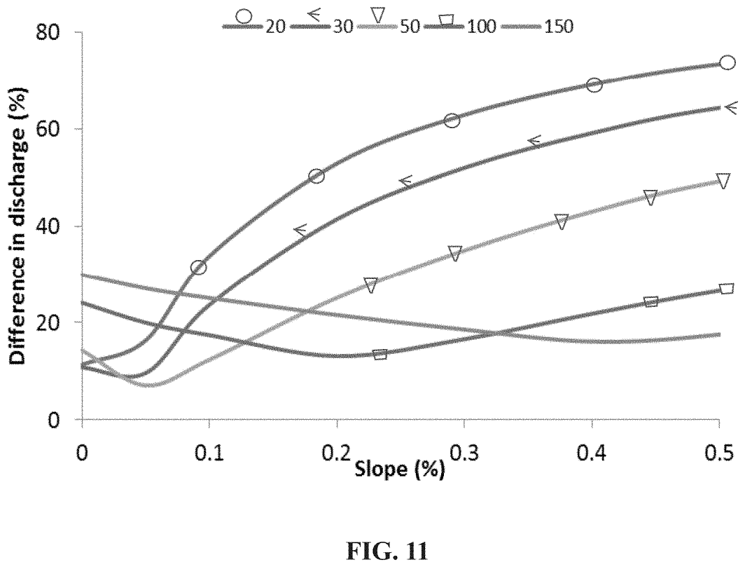

FIG. 11 is a graph plotting a difference in percentage between a dripper with high discharge to a dripper with low discharge as a function of a field slope for inlet heads about 20, 30, 50, 100 and 150 cm, with 4 drippers per meter, pipe length of about 150 m and diameter of about 25 mm, as obtained in experiments performed according to some embodiments of the present invention and listed in Table 1.

TABLE 1
Dripper discharge variation coefficient along the pipe
as a function of field slope and size of inlet head

| | Inlet head (cm) | | | |
|---|---|---|---|---|
| Slope (%) | 20 | 30 | 40 | 50 |
| 0 | 6.15 | 6.01 | 6.77 | 14.79 |
| 0.05 | 3.95 | 2.75 | 3.53 | 13.20 |
| 0.1 | 10.22 | 7.16 | 4.72 | 11.81 |
| 0.2 | 19.84 | 15.49 | 9.87 | 9.75 |
| 0.5 | 34.56 | 29.27 | 21.51 | 9.55 |
| 0.75 | 39.93 | 35.04 | 27.65 | 12.32 |
| 1 | 43.47 | 39.12 | 32.24 | 15.51 |
| 1.5 | 48.41 | 44.84 | 38.85 | 21.62 |

Pressure at the last dripper was set to an estimated value and the dripper discharge was calculated. The head loss to the next dripper was calculated and the head change due to the slope to determine the pressure at the inlet of that dripper. The discharge of the two drippers was summed and so forth to the beginning of the pipe. Microsoft Excel “goal seek” function was used to change the pressure at the last dripper to set the target inlet head according to Table I above. The field slope was varied to evaluate slopes for efficiently operating the irrigation system of the present invention given maximum discharge difference of 10%.

The pipe slope can cause higher pressure at the end (depending on the slope), and thus, higher dripper discharge. The increased discharge towards the pipe end can cause lower discharge variability along the pipe and acceptable uniformity in yields.

Flushing

All pipes can be connected at the end by a “collector” tube which can be connected to a valve at its end (not shown here). The valve can be opened periodically to clean the system during irrigation (no less than once every 2 weeks) for duration of 5-20 minutes. Opening the valve can create faster flow rate inside the pipes which can clean the drippers from accumulated dirt. This procedure can work especially well in low pressure systems (up to 2 m) where flow rates are typically slow. This valve can be controlled either manually or with a timer or using any irrigation control method. The flow rate in the pipe during the flushing depends on the pipe length (L), diameter (D) and smoothness (C), inlet head (H_{f}) and slope of the field and can be calculated using Hazen-Williams equation as provided below in EQ. III:

$$Q = \sqrt[1.852]{\frac{( {H}_{f} + L * slope ) * {C}^{1.852} * {D}^{4.87}}{10.59 * L}} \qquad ( EQ . III )$$

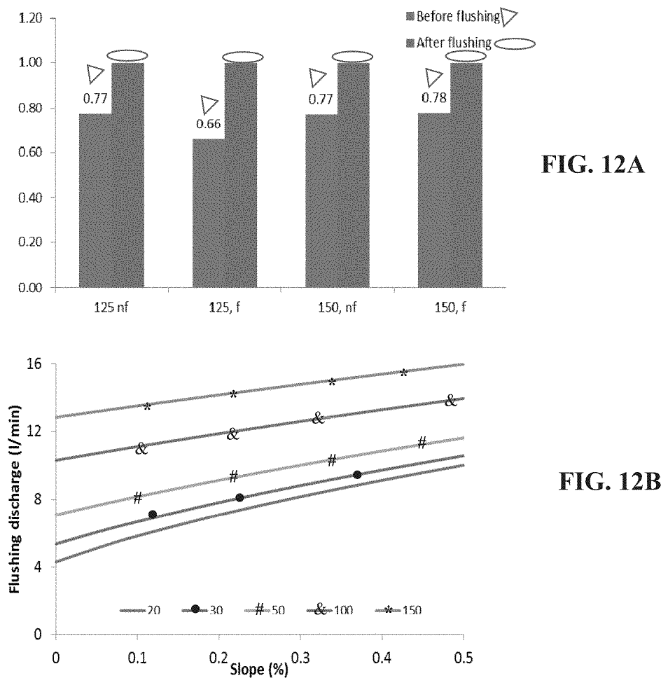

FIG. 12A is a graph showing a relative discharge of 4 different drippers before and after flushing, as obtained in experiments performed according to some embodiments of the present invention.

FIG. 12B is a graph showing water discharge in a pipe conduit during flushing as a function of a slope and an inlet pressure, for a pipe conduit having a length of about 150 m and a diameter of about 25 m, as obtained in experiments performed according to some embodiments of the present invention.

As can be seen in FIG. 12A, flushing of the pipe increased the discharge of clogged drippers to the original values.

Pipe flushing can create higher discharge and can waste water. However, pipe flushing for a short duration at the end/beginning of irrigation can keep the wasted amount of water minimal while keeping the drippers unclogged. The discharge of water through the pipe is shown in FIG. 12B, which exemplifies that pipe flushing with inlet head of about 50 cm and a slope of about 0.1% for duration of 10 minutes can waste 80 liters of water, which is a very small amount relative to surface irrigation.

The irrigation system according to the present invention can be designed to connect to existing agricultural water supply systems, which can be used for flood irrigation.

Field slope can be used as a design variable to directly influence the pipe pressure, and thus, the drippers' flow discharge along its length. The slope along the pipe can vary depending on the pipe length, the density of the drippers (number per tube length), and the water head at the inlet. As water flows in the pipe, there can be a pressure drop along the flow pathway due to friction, and therefore, there can be variations in drip flow.

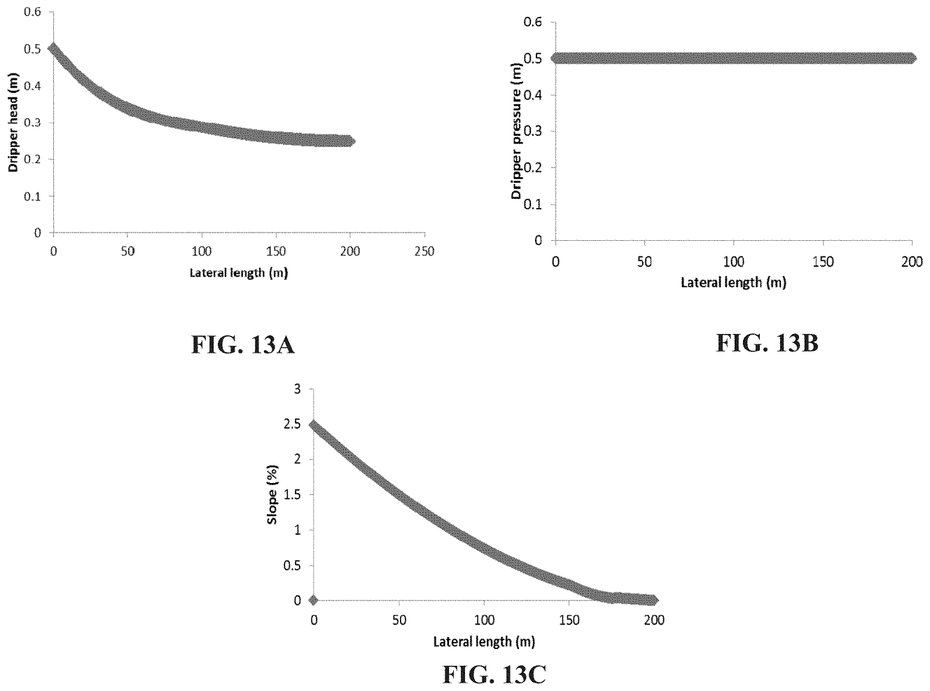

FIGS. 13A-13C are graphs of the inlet pressure as a function of the conduit length for a slope of 0° (FIG. 13A), varying slope (FIG. 13B), and slope selected to ensure a uniform flow rate (FIG. 13C), as obtained in experiments performed according to some embodiments of the present invention.

As shown in FIG. 13A, in a 200 m pipe without a slope (slope of 0°), the pressure decreased from 0.5 m at the beginning of the pipe to 0.16 m at its end. This pressure difference exhibits a difference of 67% in the flow rates. Head loss in the flow along the dripper can be calculated by the Darcy-Weisbach equation as described above. Fields that are typically irrigated by flooding can have small slopes of between about 0.05% and about 1%. Therefore, in conventional dripping systems, where the working pressures are high of about 10-14 m, the slope has no significant effect, as the height differences are negligible relative to working pressures.

According to the system of the present invention, in which the working pressure can be close to zero, small height differences along the pipe length can have a substantial effect on the pipe pressure and the drippers flow rate. The slope 330, S(l), can vary along the pipe to compensate for the pressure loss.

The slope at any point/along pipe 304 can be expressed mathematically as a slope function S(l). The slope function can be input to a controller of a shoveling tool, such as, but not limited to, a laser guided land-leveling system, to form a varying slope in a soil, and inclined irrigation pipe 304 with drippers 306 can be deploying, generally along the varying slope.

A representative slope function suitable for the present embodiments is:

$$S ( l ) = K * {f}_{d} * \frac{{q}^{2}}{{gD}_{H}^{5}} * {( L - l )}^{3} , \qquad ( EQ . IV )$$

where K is a dimensionless constant. Typically, K is from about 0.1 to about 0.5 or from about 0.1 to about 0.3, where L is the length of the irrigation pipe 304, f_{d} is a friction factor, q is a flow rate in irrigation pipe 304 per unit length, g is the gravitational acceleration, D_{H} is a hydraulic diameter of said irrigation pipe 304, and l is a distance along irrigation pipe 304 from the highest level thereof.

Another representative slope function suitable for the present embodiments is:

$$S ( l ) = G \frac{{q}^{α}}{{C}^{γ} {D}_{H}^{δ}} {( L - l )}^{β} \qquad ( EQ . V )$$

where c is a smoothness coefficient of the pipe's material, and G, α, β, γ and δ and ε are constant parameters. A typical value for G is from about 9 to about 11, a typical value for any of α, β and γ is from about 1.2 to about 2.2, and a typical value for δ is from about 4 to about 5.5. In some embodiments of the present invention at least two, more preferably all, of α, β and γ have the same value.

Since the pressure loss is greater at the beginning of the pipe and gradually decreases along the pipe, there can be a steeper slope at the beginning of the pipe and can be more moderate along the pipe length. In some embodiments of the present invention the slope S is selected also based on the distance between drippers 306. The flow rate can also be affected by the distance between drippers, since each dripper can reduce the volume of water flowing through the pipe.

At the beginning of the pipe, the water flows at a maximum flow rate, and when water reaches the first dripper after a distance x, the flow rate gradually decreases in accordance with the flow rate in the dripper and so on. In the last portion of the pipe (up to the last dripper) the flow rate in the pipe equals the flow rate in the last dripper.

In FIGS. 13B and 13C, the slope can be determined so that the drip flow along the pipe is generally uniform. FIG. 13B shows that uniform flow can be achieved by the slope shown in FIG. 13C.

As used herein the term “about” or “approximately” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of irrigation, the method comprising supplying water to an inclined irrigation pipe provided with a plurality of drippers, wherein said irrigation pipe is inclined at a varying slope and wherein said supplying is selected to provide a predetermined pressure at a highest level of said inclined irrigation pipe, said predetermined pressure and said varying slope being selected such that a water pressure along a length of said inclined irrigation pipe varies by no more than 20%.

2. A method of deploying an irrigation pipe, the method comprising:
operating a shoveling tool to form a varying slope in a soil;
deploying, generally along said varying slope, an inclined irrigation pipe having a plurality of drippers;
wherein a variation in said varying slope is selected such that when said irrigation pipe is fed with water at a predetermined pressure, a water pressure along a length of said inclined irrigation pipe varies by no more than 20%.

3. The method according to claim 1, wherein the water pressure is from about 5 cm H₂O to about 90 cm H₂O at a highest level of said inclined irrigation pipe.

4. The method according to claim 1, wherein the supplying water is by a water distribution conduit.

5. The method according to claim 1, wherein at least one of said plurality of drippers is characterized by a pressure-discharge dependence which comprises a linear relation between a discharge rate at an outlet of said dripper and an inlet pressure at an inlet of said dripper.

6. The method according to claim 5, wherein said linear relation is characterized by a coefficient of said inlet pressure which is from about 7 cubic centimeters per hour per cm H₂O to about 40 cubic centimeters per hour per cm H₂O.

7. The method according to claim 6, wherein said coefficient is from about 7 cubic centimeters per hour per cm H₂to about 20 cubic centimeters per hour per cm H₂O.

8. The method according to claim 7, wherein said coefficient is from about 9 cubic centimeters per hour per cm H₂O to about 12 cubic centimeters per hour per cm H₂O.

9. The method according to claim 5, wherein said linear relation is characterized by an offset parameter from about 0 to about 50 cubic centimeters per hour.

10. The method according to claim 9, wherein said offset parameter first coefficient is from about 10 cubic centimeters per hour to about 40 cubic centimeters per hour.

11. The method according to claim 10, wherein said offset parameter is from about 20 cubic centimeters per hour to about 30 cubic centimeters per hour.

12. The method according to claim 1, wherein a number of drippers per meter length of said inclined irrigation pipe of from about 1 to about 5.

13. The method according to claim 1, wherein for at least one pair of drippers in said pipe, a ratio between a value of said slope at a location of a first dripper of said pair and a value of said slope at a location of a second dripper of said pair, is equal or approximately equal to an nth power of a ratio between distances of a lowermost point of said pipe from said first and said second drippers of said pair, wherein said n is from about 1.5 to about 4.5.

14. An irrigation system, comprising:
an inclined irrigation pipe having a plurality of drippers configured to discharge water;
a water supply system configured to deliver water to said inclined irrigation pipe at a highest level of said inclined irrigation pipe;
wherein said irrigation pipe is inclined at a varying slope selected such that a water pressure along a length of said inclined irrigation pipe varies by no more than about 20%.

15. The irrigation system according to claim 14, further comprising a water distribution conduit.

16. The irrigation system according to claim 14, wherein said water supply system comprises at least one of: a water reservoir, a water tank and a pump.

17. A water irrigation dripper, comprising:
an external hollow element having at least one water inlet configured to intake water and at least one water outlet configured to discharge water from the dripper; and
an internal element placed inside said external hollow element to form a water pathway in a space therebetween.

18. The water irrigation dripper according to claim 17, wherein a length of said water pathway is from about 0.5 cm to about 10 cm.

19. The water irrigation dripper according to claim 18, wherein the length of said water pathway is from about 2 cm to about 5 cm.

20. The water irrigation dripper according to claim 17, wherein a diameter of said internal element is from about 0.25 mm to about 5 mm.

21. The water irrigation dripper according to claim 20, wherein the diameter of said internal element is from about 0.75 mm to about 2.5 mm.

22. The water irrigation dripper according to claim 17, wherein a hydraulic diameter of said water pathway is from about 0.01 mm to about 5 mm.

23. The water irrigation dripper according to claim 22, wherein a hydraulic diameter of said water pathway of from about 0.01 mm to about 1 mm.

24. The water irrigation dripper according to claim 17, wherein there is a plurality of water inlets at a density of from about 1 to about 10 per square centimeter.

25. The water irrigation dripper according to claim 17, wherein said water pathway at least partially surrounds said internal element.

26. The water irrigation dripper according to claim 17, wherein said water inlet has a generally elliptic shape.

27. The water irrigation dripper according to claim 26, wherein said water inlet is generally perpendicular to an outer surface of said external hollow element.

28. The water irrigation dripper according to claim 26, further comprising a water filter at said at least one water inlet.

29. The water irrigation dripper according to claim 26, comprising at least one additional water inlet, oriented diagonally with respect to a normal to an outer surface of said external hollow element.

30. An irrigation system comprising:
a water supply source; and
an irrigation pipe having a plurality of drippers configured to discharge water and being connected to said water supply source;
wherein at least one of said drippers is the dripper according to claim 17.
